(19) United States
(12) Patent Application Publication
(10) Pub. No.: US 2004/0091196 A1
(43) Pub. Date: May 13, 2004

(54) Reflection type optical device

(76) Inventors: Wei-Zhong Li, San Jose, CA (US); Qingdong Guo, Sunnyvale, CA (US)

Correspondence Address: FISH & RICHARDSON P.C., 3300 DAIN RAUSCHER PLAZA, MINNEAPOLIS, MN, 55402, US

(21) Appl. No.: 10/290,628

(22) Filed: Nov. 7, 2002

(51) Int. Cl. G02B 6/00

(52) U.S. Cl. 385/11

(57) ABSTRACT

An optical device includes a walk-off plate, a lens, a half wave plate, a reflective device, and a non-reciprocal device. The walk-off plate is adapted for coupling to a first port and a second port. The half wave plate is positioned between the walk-off plate and the lens. The half wave plate is also configured to change the polarization of the light received from the first port by a first angle. The non-reciprocal device is positioned between the lens and the reflective device, and the non-reciprocal device is also configured to rotate light passing therethrough by a second angle.

### BACKGROUND OF THE INVENTION

The present invention relates generally to optical technology.

Optical isolators, variable optical attenuators, and tap monitors are commonly used in optical communication systems and optical measurement systems. An optical isolator is a device generally designed to allow a beam of light to pass through the device in a chosen direction and to prevent the beam of light from passing through the device in the opposite of that chosen direction. A variable optical attenuator is a device generally designed in such a way that the power ratio between a light beam exiting from the device and a light beam entering the device can be adjusted over a variable range. A tap monitor is a device generally designed to monitor the power of a light beam exiting from the device or to monitor the power of a light beam entering the device.

### SUMMARY OF THE INVENTION

In one aspect, the invention provides an optical device. The optical device includes a walk-off plate, a half wave plate, a lens, a non-reciprocal device, and a reflector. The walk-off plate is configured to receive a first polarized light as an o-ray from a first port, and to transmit a second polarized light as an o-ray to enter a second port. The half wave plate is configured to receive the first polarized light from the walk-off plate for changing the polarization of the first polarized light by a first angle. The lens is configured to receive the first polarized light from the half wave plate and to transmit the second polarized light into the walk-off plate. The non-reciprocal device is configured to receive the first polarized light from the lens and to transmit the second polarized light into the lens. The non-reciprocal device is also configured to rotate light passing therethrough by a second angle. The reflector is configured to reflect the first polarized light received from the non-reciprocal device to reenter the non-reciprocal device as the second polarized light.

In another aspect, the invention provides an optical device. The optical device includes a walk-off plate, a lens, a half wave plate, a reflective device, and a non-reciprocal device. The walk-off plate is adapted for coupling to a first port and a second port. The half wave plate is positioned between the walk-off plate and the lens. The half wave plate is also configured to change the polarization of the light received from the first port by a first angle. The non-reciprocal device is positioned between the lens and the reflective device. The non-reciprocal device is also configured to rotate light passing therethrough by a second angle.

In another aspect, the invention provides a method of directing a first polarized light received from a first port to enter a second port as a second polarized light. The method includes the the following steps: (1) the step of passing the first polarized light through a walk-off plate to enter a half wave plate; (2) the step of passing the first polarized light through the half wave plate to change the polarization of the first polarized light by a first angle and to enter a lens; (3) the step of collimating the first polarized light through the lens to enter a non-reciprocal device; (4) the step of rotating the polarization of the first polarized light by a second angle including passing the first polarized light through the non-reciprocal device; (5) the step of reflecting the first polarized light incident upon a reflective device back as a second polarized light; (6) the step of rotating the polarization of the second polarized light by the second angle including passing the second polarized light through the non-reciprocal device to rotate and to enter the lens; (7) the step of collimating or directing the second polarized light through the lens to enter the walk-off plate; and (8) the step of passing the second polarized light through the lens to enter the second port.

Among the advantages of the invention may include one or more of the following. Implementations of the invention provide an optical isolator, a variable optical attenuator, and a tap monitor that can have small insertion loss, compact size, and reduced manufacturing cost. Other advantages will be readily apparent from the attached figures and the description below.

### BRIEF DESCRIPTION OF THE DRAWINGS

FIG. 1a illustrates an implementation of an optical isolator in the y-z plane.

FIG. 1b illustrates an implementation of an optical isolator in the x-z plane.

FIGS. 1c and 1d illustrate that light exiting from a PM fiber with the x-polarization becomes light with the y-polarization and does not enter an associated PM fiber.

FIG. 2 illustrates an implementation of an optical isolator that includes a tap monitor.

FIG. 3 illustrates an implementation of a variable optical attenuator.

FIG. 4 illustrates an implementation of a variable optical attenuator that includes a tap monitor.

### DETAILED DESCRIPTION OF THE INVENTION

The present invention relates to an improvement in optical technology. The following description is presented to enable one of ordinary skill in the art to make and use the invention and is provided in the context of a patent application and its requirements. Various modifications to the invention will be readily apparent to those skilled in the art and the generic principals herein may be applied to other embodiments. Thus, the present invention is not intended to be limited to the embodiments shown, but is to be accorded the widest scope consistent with the principals and features described herein.

The present invention will be described in terms of an optical isolator, a variable optical attenuator, and a tap monitor each having specific components having specific configurations. Similarly, the present invention will be described in terms of components having specific relationships, such as distances or angles between components. However, one of ordinary skill in the art will readily recognize that the devices and systems described can include other components having similar properties, other configurations, and other relationships between components.

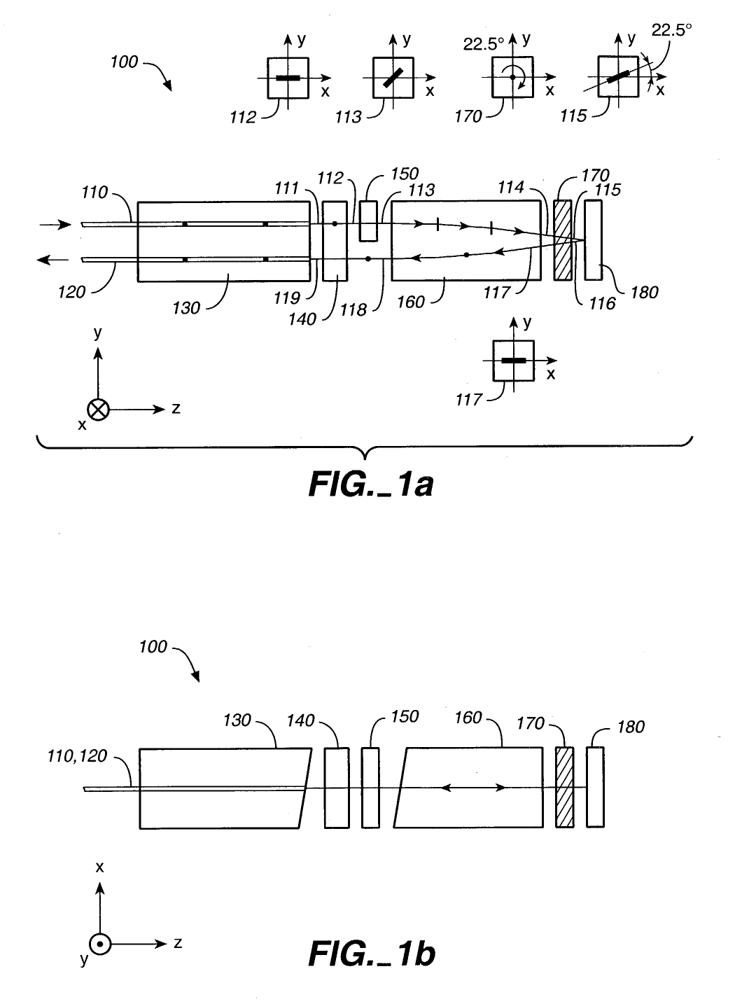

FIGS. 1a and 1b illustrate an implementation of an optical isolator 100, respectively, in the y-z plane and the x-z plane. Optical isolator 100 includes a walk-off plate 140, a half-wave plate 150, a lens 160 such as a GRIN lens, non-reciprocal device 170 such as a Faraday rotator, and a reflector 180. Optical isolator 100 can be coupled to a Polarization Maintenance (“PM”) fiber 110 and a PM fiber 120. PM fibers 110 and 120 can be fixed with a capillary 130.

Walk-off plate 140 is designed in such a way that light entering walk-off plate 140 as an o-ray is not deflected, while light entering walk-off plate 140 as an e-ray is deflected. In one implementation, walk-off plate 140 is designed in such a way that light with the x-polarization enters walk-off plate 140 as an o-ray and light with the y-polarization enters walk-off plate 140 as an e-ray.

In one implementation, half-wave plate 150 is a device designed to perform the following functions: (1) light with the x-polarization passing through the device in the positive z-direction becomes light with the x+y polarization; (2) light with the x−y polarization passing through the device in the negative z-direction becomes light with the y-polarization.

In one implementation, lens 160 is a device designed to perform the following functions: (1) light exiting from PM fiber 110 is collimated, and after being reflected by reflective device 180, reenters PM fiber 120; (2) light exiting from PM fiber 120 is also collimated.

In one implementation, non-reciprocal device 170 is a device designed in such a way that the polarization of light passing through the device, either in the positive or the negative z-direction, is rotated substantially negative 22.5 degrees with respect to the positive z-axis.

FIGS. 1a and 1b illustrate that light 111 exiting from PM fiber 110 with the x-polarization enters PM fiber 120 as light 119 with the x-polarization. More specifically, light 111 exiting from PM fiber 110 with the x-polarization passes through walk-off plate 140 as an o-ray without being deflected and becomes light 112. Light 112 enters half-wave plate 150 with the x-polarization and exits from half-wave plate 150 as light 113 with the x+y polarization. Light 113 is collimated by lens 160 and exits from lens 160 as light 114. Light 114 enters non-reciprocal device 170 with the x+y polarization and exits from non-reciprocal device 170 as light 115 with the cos(22.5)x+sin(22.5)y polarization. The polarization of light 114 is rotated substantially negative 22.5 degrees with respect to the positive z-axis. Light 115 is reflected by reflector 180 (e.g., a mirror) and becomes light 116 traveling a direction such that light 116 can be directed into PM fiber 120 using lens 160.

Light 116 enters non-reciprocal device 170 with the cos(22.5)x+sin(22.5)y polarization and exits from non-reciprocal device 170 as light 117 with the x-polarization. The polarization of light 116 is rotated substantially negative 22.5 degrees with respect to the positive z-axis. Light 117 passes through lens 160 and becomes light 118. Light 118 with the x-polarization passes through walk-off plate 140 as an o-ray without being deflected and becomes light 119. Light 119 enters PM fiber 120 with the x-polarization.

While light exiting from PM fiber 110 enters PM fiber 120, light exiting from PM fiber 120 does not enter PM fiber 110. Therefore, optical isolator 100 provides optical isolation between PM fibers 110 and 120. The isolation function is described in greater detail below in association with FIGS. 1c and 1d.

FIGS. 1c and 1d illustrate that light 121 exiting from PM fiber 120 with the x-polarization becomes light 129 with the y-polarization and does not enter PM fiber 110. More specifically, light 121 exiting from PM fiber 120 with the x-polarization passes through walk-off plate 140 as an o-ray without being deflected and becomes light 122. Light 122 is collimated by lens 160 and exits from lens 160 as light 123. Light 123 enters non-reciprocal device 170 with the x-polarization and exits from non-reciprocal device 170 as light 124 with the cos(22.5)x−sin(22.5)y polarization. The polarization of light 123 is rotated substantially negative 22.5 degrees with respect to the positive z-axis. Light 124 is reflected by reflector 180 and becomes light 125.

Light 125 enters non-reciprocal device 170 with the cos(22.5)x−sin(22.5)y polarization and exits from non-reciprocal device 170 as light 126 with the x−y polarization. The polarization of light 125 is rotated substantially negative 22.5 degrees with respect to the positive z-axis. Light 126 passes through lens 160 and becomes light 127. Light 127 enters half-wave plate 150 with the x−y polarization and exits from half-wave plate 150 as light 128 with the y-polarization. Light 128 with the y-polarization enters walk-off plate 140 as an e-ray and gets deflected as light 129. After being deflected by walk-off plate 140, light 129 does not enter PM fiber 110.

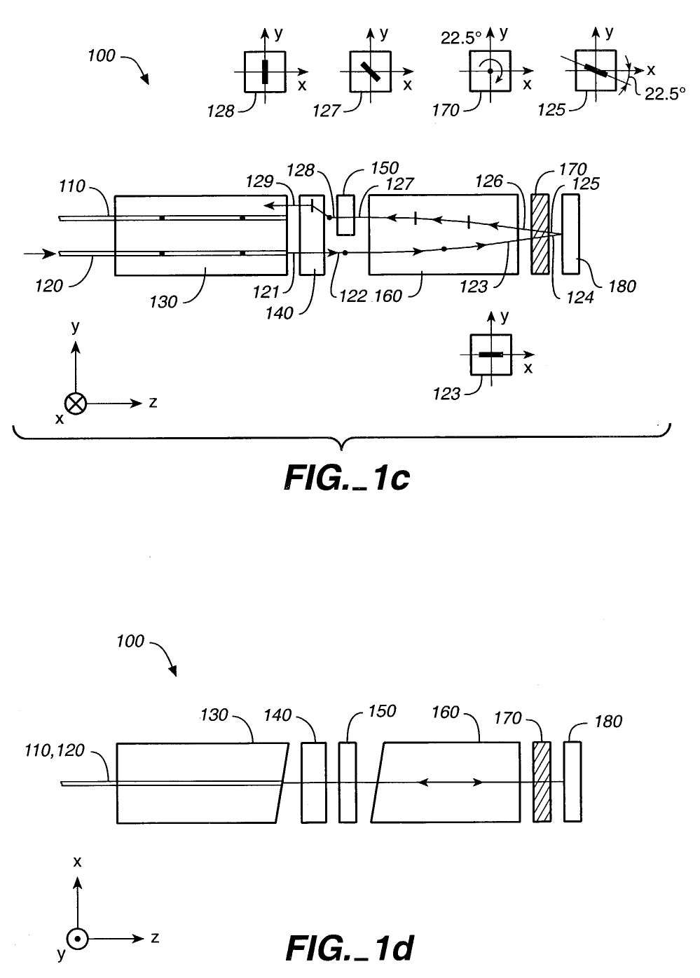

As shown in FIG. 2, optical isolator 100 in FIGS. 1a-1d can be modified to become an optical isolator 200 that includes a tap monitor. More specifically, reflector 180 in FIGS. 1a-1d is replaced with partial reflector 280. A photo detector 210 is positioned behind partial reflector 280. When light 115 is reflected by partial reflector 280 and becomes light 116, a portion of light 115 transmits through partial reflector 280 and becomes light 217. Light 217 is monitored by photo detector 210. Partial reflector 280 can be designed in such a way that the power of light 217 is proportional to the power of light 111 or light 119. Consequently, the power of light 111 or light 119 can be monitored using light 217.

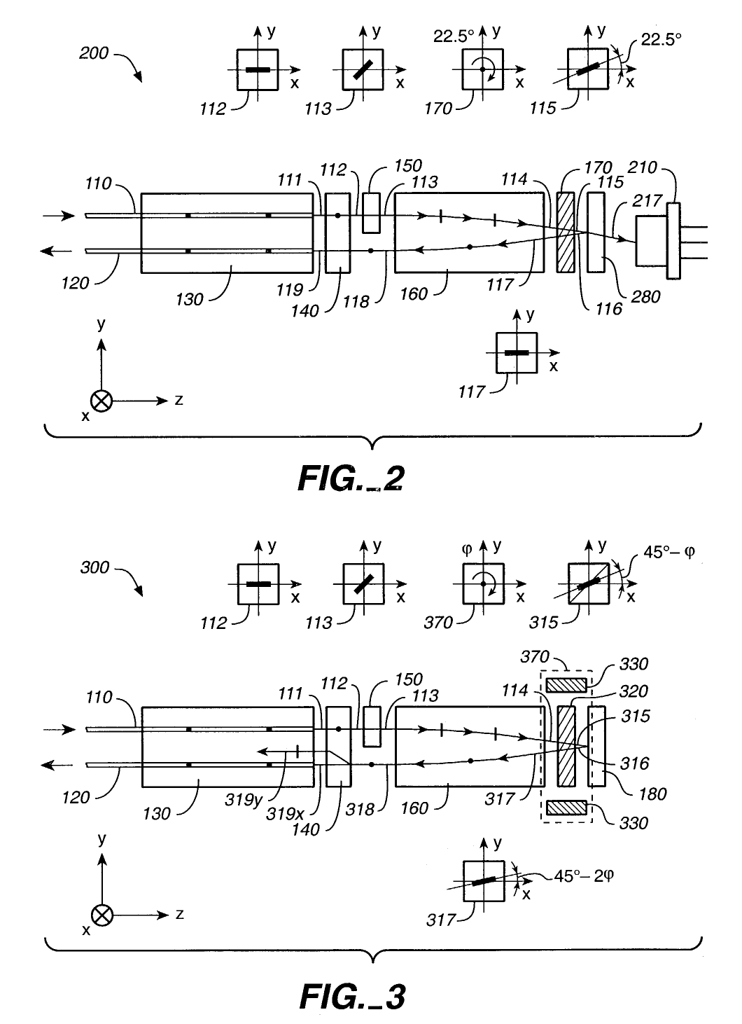

As shown in FIG. 3, optical isolator 100 in FIGS. 1a-1d can be modified to become a variable optical attenuator (“VOA”) 300. More specifically, non-reciprocal device 170 in FIGS. 1a-1d is replaced with a variable non-reciprocal device 370: Variable non-reciprocal device 370 is a device designed in such a way that the polarization of light passing through the device, either in the positive or the negative z-direction, is rotated by a variable angle φ that can be controlled by external parameters (e.g., electric current).

In one implementation, variable non-reciprocal device 370 includes a Faraday rotator 320 and an electromagnetic ring 330. The variable angle φ can be changed by changing the strength of the magnetic field generated by electromagnetic ring 330. The strength of the magnetic field generated by electromagnetic ring 330 can be controlled by external parameters, such as, electric current.

In FIG. 3, light 111 exiting from PM fiber 110 with the x-polarization becomes light 114 with the x+y polarization after passing through walk-off plate 140, half-wave plate 150, and lens 160. Light 114 enters variable non-reciprocal device 370 with the x+y polarization and exits from variable non-reciprocal device 370 as light 315 with the cos(45−φ)x+sin(45−φ)y polarization. Here the polarization of light 114 is rotated negative φ degrees with respect to the positive z-axis. Light 315 is reflected by reflector 180 and becomes light 316 traveling in a direction such that light 316 can be directed into PM fiber 120 using lens 160.

Light 316 enters variable non-reciprocal device 370 with the cos(45−φ)x+sin(45−φ)y polarization and exits from variable non-reciprocal device 370 as light 317 with the cos(45−2φ)x+sin(45−2φ)y polarization. Here the polarization of light 316 is rotated negative φ degrees with respect to the positive z-axis. Light 317 passes through lens 160 and becomes light 318. Light 118 includes a component with the x-polarization and a component with the y-polarization. The component with the x-polarization has an power intensity that is proportional to [cos(45−2φ)]², and the component with the y-polarization and proportional to [sin(45−2φ)]².

The component with the x-polarization passes through walk-off plate 140 as an o-ray without being deflected and becomes light 319x. Light 319x enters PM fiber 120 with the x-polarization. The component with the y-polarization passes through walk-off plate 140 as an e-ray and gets deflected as light 319y. After being deflected by walk-off plate 140, light 319y does not enter PM fiber 120. Consequently, a portion of light 111 exiting from PM fiber 110 with the x-polarization enters PM fiber 120 as light 119x with the x-polarization. The power intensity ratio between the light entering PM fiber 120 and the light exiting from PM fiber 110 is proportional to [cos(45−2φ)]². In the special case that φ=22.5 degrees, a maximum amount of light is transferred from PM fiber 110 to PM fiber 120.

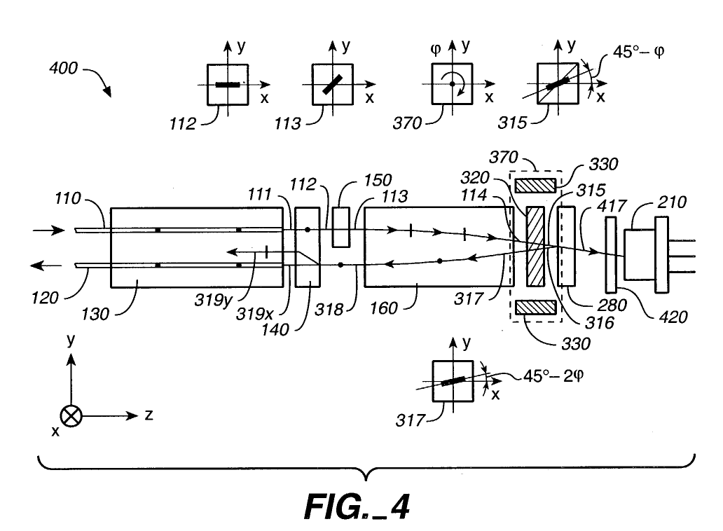

As shown in FIG. 4, VOA 300 in FIG. 3 can be modified to become VOA 400 that includes a tap monitor. More specifically, reflector 180 in FIGS. 1a-1d is replaced with partial reflector 280. A polarization filter 420 and a photo detector 210 are positioned behind partial reflector 280. When light 315 is reflected by partial reflector 280 and becomes light 316, a portion of light 315 transmits through partial reflector 280 and becomes light 417. Light 417 passes through polarization filter 420 and is monitored by photo detector 210. Partial reflector 280 and polarization filter 420 are designed in such a way that the power of light 319x is proportional to the power of light 417. Consequently, the power of light 319x can be monitored using light 417.

Implementations of walk-off plate 140 include one or more of the following. Walk-off plate 140 can be designed in such a way that light with the x-polarization enters walk-off plate 140 as an o-ray and light with the y-polarization enters walk-off plate 140 as an e-ray. Walk-off plate 140 can also be designed in such a way that light with the cos(θ)x+sin(θ)y polarization enters walk-off plate 140 as an o-ray and light with the sin(θ)x-cos(θ)y polarization enters walk-off plate 140 as an e-ray. θ can be an arbitrary angle.

Implementations of half-wave plate 150 include one or more of the following. Half-wave plate 150 can be designed in such a way that the optical axis of half-wave plate 150 forms a substantially 22.5 degrees angle with respect to the polarization direction of the o-rays in walk-off plate 140. Half-wave plate 150 can also be designed in such a way that the optical axis of half-wave plate 150 forms a substantially 67.5 degrees angle with respect to the polarization direction of the o-rays in walk-off plate 140.

Implementations of lens 160 include one or more of the following. Lens 160 can be a GRIN lens. Lens 160 can also be other type of lenses.

Implementations of non-reciprocal device 170 include one or more of the following. Non-reciprocal device 170 can be a device designed in such a way that the polarization of light passing through the device is rotated substantially negative 22.5 degrees with respect to the positive z-axis. Non-reciprocal device 170 can also be a device designed in such a way that the polarization of light passing through the device is rotated substantially positive 22.5 degrees with respect to the positive z-axis. Non-reciprocal device 170 can be a Faraday rotator.

A method and system has been disclosed for providing optical isolators, variable optical attenuators, and tap monitors. Although the present invention has been described in accordance with the implementations shown, one of ordinary skill in the art will readily recognize that there could be variations to the implementations and those variations would be within the spirit and scope of the present invention. Accordingly, many modifications may be made by one of ordinary skill in the art without departing from the spirit and scope of the appended claims.

What is claimed is:

1. An optical device comprising:
a walk-off plate configured to receive a first polarized light as an o-ray from a first port, and to transmit a second polarized light as an o-ray to enter a second port;
a half wave plate configured to receive the first polarized light from the walk-off plate for changing the polarization of the first polarized light by a first angle;
a lens configured to receive the first polarized light from the half wave plate and to transmit the second polarized light into the walk-off plate;
a non-reciprocal device configured to receive the first polarized light from the lens and to transmit the second polarized light into the lens, the non-reciprocal device configured to rotate light passing therethrough by a second angle; and
a reflector configured to reflect the first polarized light received from the non-reciprocal device to reenter the non-reciprocal device as the second polarized light.

2. The optical device of claim 1 wherein the first angle is substantially 45 degrees.

3. The optical device of claim 1 wherein the second angle is substantially 22.5 degrees.

4. The optical device of claim 1 wherein the reflective device is essentially a complete reflector.

5. The optical device of claim 1 wherein the reflective device is a partial reflector.

6. The optical device of claim 5 further comprising a photo detector for receiving light transmitted through the partial reflector.

7. The optical device of claim 1 wherein the first port is coupled to an end of a first polarization maintenance optical fiber, and the second port is coupled to an end of a second polarization maintenance optical fiber.

8. The optical device of claim 7 wherein the lens is configured to collimate light from the first polarization maintenance fiber and light from the second polarization maintenance fiber.

9. The optical device of claim 7 further comprising a capillary for fixedly holding the first and second polarization maintenance optical fibers.

10. The optical device of claim 1 wherein the non-reciprocal device is a Faraday rotator.

11. The optical device of claim 1 wherein the non-reciprocal device is a variable non-reciprocal device.

12. The optical device of claim 11 wherein the variable non-reciprocal device includes an electromagnetic ring, and a Faraday rotator positioned proximate to the electromagnetic ring.

13. The optical device of claim 12 wherein the Faraday rotator is positioned inside the electromagnetic ring

14. The optical device of claim 1 wherein the second angle is a variable angle that is controllable with a control parameter.

15. The optical device of claim 14 wherein the control parameter is electric current.

16. The optical device of claim 1 wherein the lens is a GRIN lens.

17. An optical device comprising:
a walk-off plate adapted for coupling to a first port and a second port;
a lens;
a half wave plate positioned between the walk-off plate and the lens, the half wave plate configured to change the polarization of the light received from the first port by a first angle;
a reflective device;
a non-reciprocal device positioned between the lens and the reflective device, the non-reciprocal device configured to rotate light passing therethrough by a second angle.

18. The optical device of claim 17 wherein the first angle is substantially 45 degrees.

19. The optical device of claim 17 wherein the second angle is substantially 22.5 degrees.

20. The optical device of claim 17 wherein the reflective device is essentially a complete reflector.

21. The optical device of claim 17 wherein the reflective device is a partial reflector.

22. The optical device of claim 21 further comprising a photo detector for receiving light transmitted through the partial reflector.

23. The optical device of claim 17 wherein the first port is coupled to an end of a first polarization maintenance optical fiber, and the second port is coupled to an end of a second polarization maintenance optical fiber.

24. The optical device of claim 23 wherein the lens is configured to collimate light from the first polarization maintenance fiber and light from the second polarization maintenance fiber.

25. The optical device of claim 23 further comprising a capillary for holding the first and second polarization maintenance optical fibers.

26. The optical device of claim 17 wherein the non-reciprocal device is a Faraday rotator.

27. The optical device of claim 17 wherein the non-reciprocal device is a variable non-reciprocal device.

28. The optical device of claim 27 wherein the variable non-reciprocal device includes an electromagnetic ring, and a Faraday rotator positioned proximate to the electromagnetic ring.

29. The optical device of claim 28 wherein the Faraday rotator is positioned inside the electromagnetic ring

30. The optical device of claim 17 wherein the second angle is a variable angle that is controllable with a control parameter.

31. The optical device of claim 30 wherein the control parameter is electric current.

32. The optical device of claim 17 wherein the lens is a GRIN lens.

33. A method of directing a first polarized light received from a first port to enter a second port as a second polarized light comprising the steps of:
passing the first polarized light through a walk-off plate to enter a half wave plate;
passing the first polarized light through the half wave plate to change the polarization of the first polarized light by a first angle and to enter a lens;
collimating the first polarized light through the lens to enter a non-reciprocal device;
rotating the polarization of the first polarized light by a second angle including passing the first polarized light through the non-reciprocal device;
reflecting the first polarized light incident upon a reflective device back as a second polarized light;
rotating the polarization of the second polarized light by the second angle including passing the second polarized light through the non-reciprocal device to rotate and to enter the lens;
collimating or directing the second polarized light through the lens to enter the walk-off plate; and
passing the second polarized light through the lens to enter the second port.

34. The method of claim 33 wherein the first angle is substantially 45 degrees.

35. The method of claim 33 wherein the second angle is substantially 22.5 degrees.

36. The method of claim 33 wherein the step of reflecting includes reflecting the first polarized light incident upon a compete reflector back as a second polarized light.

37. The method of claim 33 wherein the step of reflecting includes reflecting the first polarized light incident upon a partial reflector back as a second polarized light.

38. The method of claim 37 further comprising the step of detecting light transmitted through the partial reflector with a photo detector.

39. The method of claim 33 wherein the first port is the end of a first polarization maintenance optical fiber, and the second port is the end of a second polarization maintenance optical fiber.

40. The method of claim 39 further comprising collimating light from the first polarization maintenance fiber and light from the second polarization maintenance fiber.

41. The method of claim 39 further comprising fixedly holding the first and second polarization maintenance optical fibers with a capillary.

42. The method of claim 33 wherein the non-reciprocal device is a Faraday rotator.

43. The method of claim 33 wherein the non-reciprocal device is a variable non-reciprocal device.

44. The method of claim 43 wherein the variable non-reciprocal device includes an electromagnetic ring, and a Faraday rotator positioned proximate to the electromagnetic ring.

45. The method of claim 44 wherein the Faraday rotator is positioned inside the electromagnetic ring

46. The method of claim 33 further comprising controlling the second angle with a control parameter.

47. The method of claim 46 wherein the control parameter is electric current.

48. The method of claim 33 wherein the lens is a GRIN lens.

49. The method of claim 33 wherein the step of passing the first polarized light through a walk-off plate includes passing the first polarized light through a walk-off plate as an o-ray.
